(19) United States
(12) Patent Application Publication
(10) Pub. No.: US 2026/0044993 A1
(43) Pub. Date: Feb. 12, 2026

(54) SYSTEMS AND METHODS FOR A TEXT-TO-VIDEO GENERATION FRAMEWORK

(71) Applicant: Salesforce, Inc., San Francisco, CA (US)

(72) Inventors: Can Qin, Somerville, MA (US); Krithika Ramakrishnan, New York, NY (US); Congying Xia, Chicago, IL (US); Yihao Feng, Austin, TX (US); Michael S. Ryoo, New York, NY (US); Lifu Tu, Santa Clara, CA (US); Zeyuan Chen, Mountain View, CA (US); Ran Xu, Mountain View, CA (US); Caiming Xiong, Menlo Park, CA (US)

(21) Appl. No.: 19/008,047

(22) Filed: Jan. 2, 2025

Related U.S. Application Data
(60) Provisional application No. 63/681,415, filed on Aug. 9, 2024.

(51) Int. Cl. G06T 11/00

(52) U.S. Cl. CPC G06T 11/00

(57) ABSTRACT

Embodiments described herein provide a generation model comprising a video-specific variational auto-encoder (VAE) for effective compression of video pixel information with reduced spatial and temporal dimensions and a video diffusion transformer (vDiT) to generate latent representations of frames. Specifically, the VAE may, instead of encoding each frame independently, incorporate both temporal and spatial compression. This significantly decreases the token length, improves the computational cost of training and inference, and facilitates the generation of long videos. The encoded training video, in the form of latent representations from a VAE encoder may then be passed to the vDiT to reconstruct the latent representations during training. The trained vDiT may then generate latent representations of a video in response to a text input, and the latent representations may be converted to a video output by a VAE decoder.

### CROSS REFERENCE

This application is a nonprovisional of and claims priority under 35 U.S.C. 119 to U.S. provisional application No. 63/681,415, filed Aug. 9, 2024, which is hereby expressly incorporated by reference herein in its entirety.

### TECHNICAL FIELD

The embodiments relate generally to machine learning systems for machine learning systems and generative artificial intelligence (AI) systems, and more specifically to systems and methods for a text-to-video generation framework.

### BACKGROUND

Generative AI systems have been used in generating visual content, such as an image, a video, a three-dimensional (3D) object, and/or the like. For example, a video generation AI model may create videos depicting both realistic and imaginative scenes based on an input text description, e.g., “a dog running through snow.” However, due to the size of video and/or image data, training a generative AI model to generate video and/or image data can be computationally expensive and slow at inference. For example, a 100 frame video of 720p spatial resolution would translate into a latent space of size 100×4×90×160 that contains 360000 tokens for processing.

### BRIEF DESCRIPTION OF THE DRAWINGS

FIG. 1 is a simplified diagram illustrating an overview of a text-to-video (t2v) generation model, according to some embodiments.

FIG. 2A is a simplified diagram illustrating an example training framework of the t2v generation model described in FIG. 1, according to some embodiments.

FIG. 2B is a simplified diagram illustrating an exemplary training framework for a denoising diffusion model for generating a video given a conditioning input such as a text prompt, according to some embodiments

FIGS. 2C-2D are simplified diagrams illustrating ab example modules in the t2v generation model described in FIG. 2A, according to some embodiments.

FIG. 3 is a simplified diagram illustrating an example long video compression encoding process in the training framework described in FIG. 2A, according to some embodiments.

FIG. 4 is a simplified diagram illustrating a data pipeline for generating video-text training data for training the text-to-video generation model described in FIG. 1, according to some embodiments.

FIG. 5 is a simplified diagram illustrating the motion detection and re-clipping of training videos in the data pipeline described in FIG. 4, according to some embodiments.

FIG. 6 is a simplified diagram illustrating a distributed implementation of the data pipeline described in FIG. 4, according to some embodiments.

FIG. 7 is a simplified diagram illustrating a computing device implementing the text-to-generation framework described in FIG. 1, according to one embodiment described herein.

FIG. 8 is a simplified diagram illustrating the neural network structure implementing the text-to-generation framework described in FIG. 7, according to some embodiments.

FIG. 9 is a simplified block diagram of a networked system suitable for implementing text-to-generation framework described in FIGS. 1-8 and other embodiments described herein.

FIG. 10 is a simplified logic flow diagram of automatically generating a video based on a text description based on the text-to-generation framework described in FIGS. 1-9 and other embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

### Overview

A text-to-video generation system may convert a textual input into video content automatically. This process may involve natural language processing (NLP) algorithms to understand the text input and computer vision models to generate corresponding visual elements. Existing video generation systems may use variational auto-encoders (VAE) to encode each frame of a training video. The dimensionality of the latent space is determined by the output of the VAE. A latent space with small dimensionality means that the input pixel information are highly compressed, which makes the reconstruction of the video more difficult. On the other hand, a latent space with large dimensionality improves reconstruction accuracy but computationally expensive. For example, if each frame is independently encoded using an image VAE, a 100-frame video of 720p spatial resolution would translate into a latent space of size 100×4×90×160 that contains 360000 tokens. This makes the video generation model both computationally expensive in training and slow at inference.

In view of the need of computationally efficient text-to-video generation, embodiments described herein provide a generation model comprising a video-specific VAE for effective compression of video pixel information with reduced spatial and temporal dimensions and a video diffusion transformer (vDiT) to generate latent representations of frames. Specifically, the VAE may, instead of encoding each frame independently, incorporate both temporal and spatial compression. This significantly decreases the token length, improves the computational cost of training and inference, and facilitates the generation of long videos. The encoded training video, in the form of latent representations from a VAE encoder may then be passed to the vDiT to reconstruct the latent representations during training. The trained vDiT may then generate latent representations of a video in response to a text input, and the latent representations may be converted to a video output by a VAE decoder.

In one embodiment, to further reduce computation during long video encoding, a long training video may be split into multiple segments, which are encoded individually with overlapping frames to maintain good temporal consistency. The individually encoded segments may then be combined into one latent variable for input to the vDiT.

In one embodiment, the text-to-video generation framework 100 comprises a video encoder, a video diffusion transformer, a text encoder, and a video decoder. During training, video-text pairs comprising video data and corresponding text descriptions may be used. The video encoder may be a variational auto-encoder (VAE) that may be implemented as an encoder and/or a decoder. The Video VAE encoder G( ) may map video data x in to a latent space, e.g., f=G (x) where the size of the latent representation f is much smaller than the size of the original video data x. The latent representation f is then fed to the video diffusion transformer, e.g., at the spatial-temporal temporal Transformer block at each Transformer layer. The stacking of spatial-temporal Transformer blocks may capture spatial features and temporal features from the latent representation f.

In one embodiment, a text encoder, such as the language model T5, may encode a text input, e.g., “a butterfly under the sea with crystal body of water,” into a text representation. The text representation may then be fed to the cross-attention module at each Transformer layer of the video diffusion Transformer. The cross-attention module may then perform cross-attention between the text representation, and spatial-temporal feature representations of the video data.

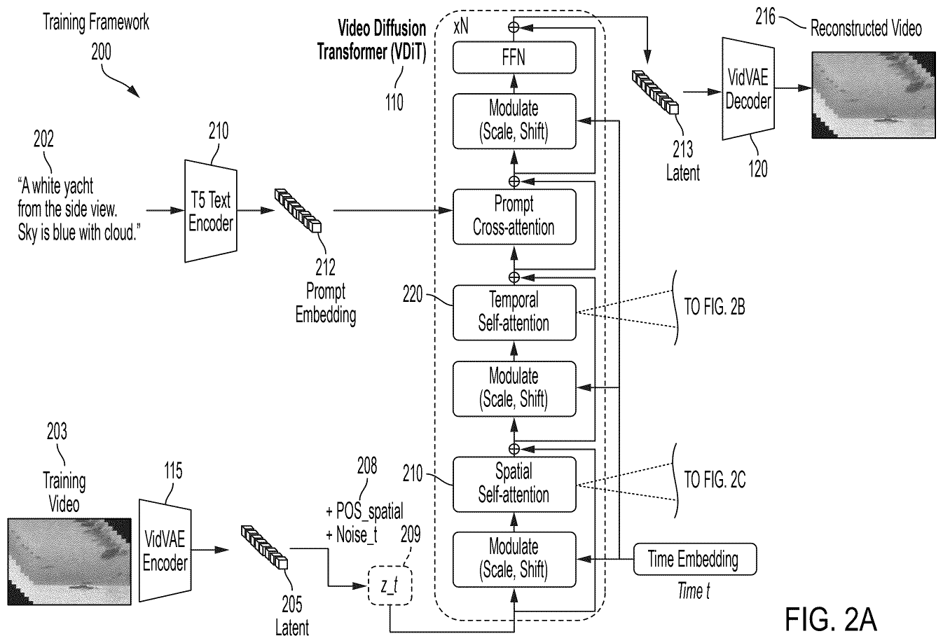

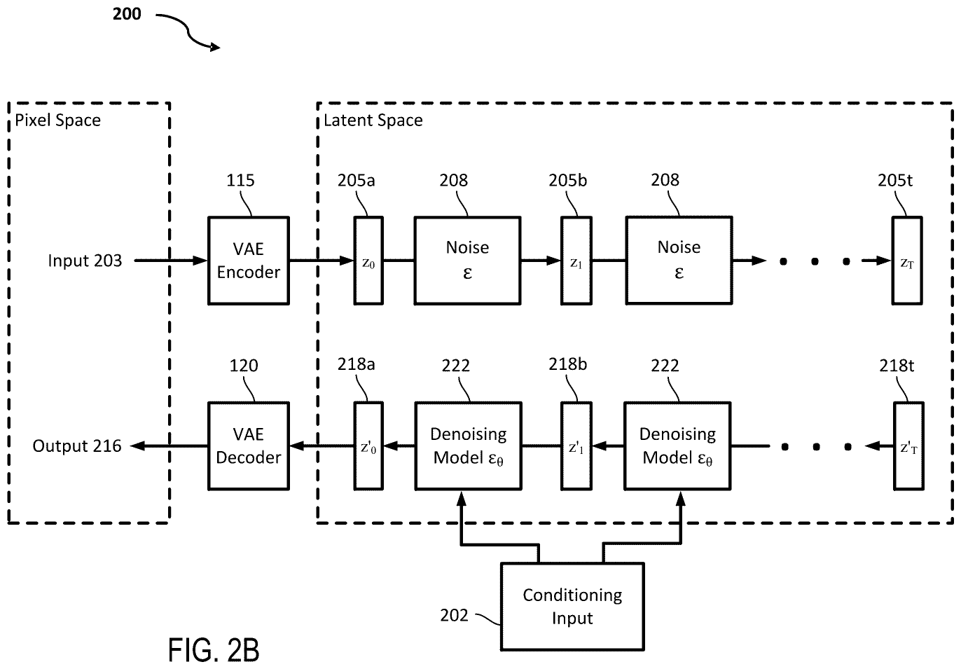

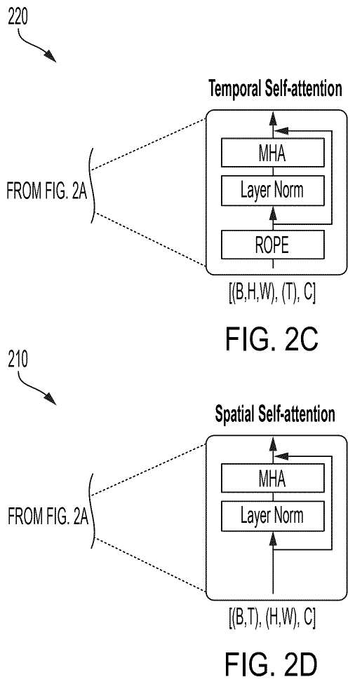

In one embodiment, the Video-diffusion Transformer (vDiT) may incorporate transformer blocks with both temporal and spatial self-attention layers to encode spatial and temporal position information from latent representations of videos. This allows for effective generalization across different lengths, aspect ratios, and resolutions. Moreover, the vDiT is trained on a diverse dataset that includes videos of 240p, 512×512, 480p, 720p, and 1024×1024 resolutions. The video VAE training takes approximately 40 H100 days, while the DiT model requires around 642 H100 days. The vDiT also outputs the cross-attended latent representation to a video VAE decoder, D( ), which in turn maps the cross-attended latent representation back to the pixel space as \hat{x}= [symbol] (f) where the reconstructed video \hat{x} may be compared with the input video x to compute a loss, such as a reconstruction loss. Additional discussion of the training of the video diffusion Transformer may be described in FIG. 2B.

During inference, an input text may be fed to the video generation framework, e.g., at the text encoder, which in turn outputs a video.

In one embodiment, a training data pipeline may be built to generate high-quality video-text pairs to train the generative video model on how to map text to video modalities. The data processing pipeline includes removing duplicate data, analysis of aesthetics and motion, optical character recognition (OCR), and other processing steps. The process also employs a video captioning model that creates captions (e.g., with an average of 84.4 words). Thus, the data pipeline may generate a training dataset with over 13 million high-quality video-text pairs to train a video generation model.

In this way, a video generation model comprising a VAE encoder, vDiT, a VAE decoder can thus be trained using the training dataset with much improved training efficiency. The trained vDiT and VAE decoder may generate videos with over 100 frames at 720p resolution in an end-to-end manner. Video generation technology is thus improved.

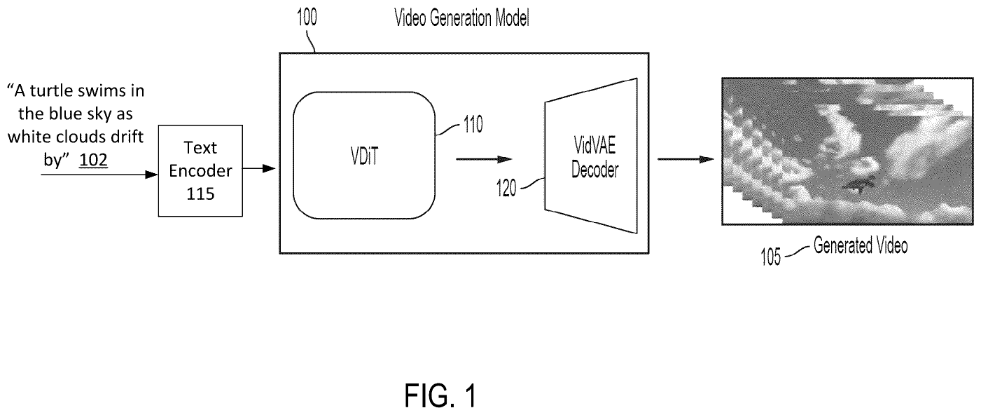

FIG. 1 is a simplified diagram illustrating an overview of a text-to-video (t2v) generation model, according to some embodiments. A video generation model 100 may comprise a video VAE decoder 120, a VDiT 110 and a Language Model (Text Encoder 210).

At inference, as shown in FIG. 1, a text description 102 depicting a scene may be encoded by text encoder 210 into text embeddings, which in turn may be passed to the vDiT 110. The vDiT 110 may in turn convert the text representation into a video representation, which is decoded by the video VAE decoder 120 into an output video 105. In this way, a new video 105 is generated based on the text description 102.

At training, a video VAE encoder 115 may be employed to encode a training video to train the vDiT 110 and/or the video VAE decoder 120. Additional details of the operations of vDiT 110 and the training framework is provided below in relation to FIGS. 2A-2C.

FIG. 2A is a simplified diagram illustrating an example training framework 200 of the t2v generation model described in FIG. 1, according to some embodiments. Training framework 200 of the video generation model 100 may comprise a video VAE encoder 115, a video VAE decoder 120, a VDiT 110 and a Language Model (Text Encoder 210).

In one embodiment, a training text 202 and a paring training video 203 may be fed to the training framework 200, which in turn produces a reconstructed video 216. The reconstructed video 216 may then be compared with the training video 203 to guide the training of vDiT 110, VAE encoder 115, and/or VAE decoder 120.

In one embodiment, the training text 202 may be encoded by a text encoder 210. For example, the text encoder 210 may comprise a T5 model with a token length limit of 250. The extracted text features, e.g., in the form of text prompt embeddings 212, are integrated into the backbone of vDiT 110 through a cross-attention layer as described below.

In one embodiment, the VideoVAE encoder 115 may take an input training video 203 and produce a latent encoding 205. The video VAE encoder 115 may efficiently compress videos not only in the spatial dimension but also temporally, thereby enhancing training speed represents the number of frames, H×W represent the spatial dimension of each frame, and each frame takes an RGB image format, the video VAE encoder 115 encodes x into z=ε(x), a latent representation 205, and the video VAE decoder [symbol] 120 reconstructs the video from a latent representation, rendering \tilde{x}= [symbol] (z)= [symbol] (ε(x)), where z∈R^{t×h×w×c}. Here, the video VAE encoder 115 not only reduces the spatial dimensionality by a factor of f=H/h=W/w but also compresses temporally by a factor of s=T/t, e.g., a temporal compression of ¼, ⅛, and/or the like.

The three-dimensional (3D) video VAE encoder 115 (e.g., for encoding vndeso) may be constructed by adapting a pretrained 2D image VAE encoder with a spatial compression rate of ⅛. This adaption involves the incorporation of time compression layers into the model: 1) all 2D convolutional layers (Conv2d) in the 2D VAE encoders are replaced with Causal Convolutional 3D layers (CausalConv3D)—in this way, CausalConv3D may provide that only subsequent frames have access to information from previous frames, thereby preserving the temporal directionality from past to future. 2) a time downsampling layer following the spatial downsampling layers is adopted to compress the video data along the temporal dimension. For example, a 3D average pooling technique may be applied, e.g., two temporal downsampling layers may be adopted, each reducing the temporal resolution by half. Consequently, the overall time compression factor achieved is ¼, meaning that every four frames are condensed into a single latent representation. The spatial compression ratio remains ⅛.

In one embodiment, the resulting latent representation 205 (after compressed both spatially and temporally) may be used to train the vDiT 110. The vDiT 110 may comprise a latent diffusion model which may be trained with denoising loss and uses Diffusion Transformer (DiT) as the diffusion backbone. For example, during training, a noise 208 may be iteratively added to the latent representation 205 to form a noised latent representation Zt 209, which is in turn input to the vDiT 110. The vDiT 110 is trained to estimate and/or remove the added noise 208 from the noised latent representation 209 to reconstruct a latent representation 213. Such denoising step is repeated iteratively so that over a number of iterations (e.g., 50 iterations), the reconstructed latent representation 213 may be considered as a denoisedi version of the noised latent representation Zt 209, which is supposedly close to the original latent representation 205. In this way, vDiT 110 may be trained by comparing the reconstructed latent representation 213 and the original latent representation 205.

After vDiT 110 has been trained to denoise an input representation vector, at inference, the vDiT 110 may receive the text prompt 202 describing visual content (or in the form of text embedding 212 that is encoded by the text encoder 210). The vDiT 110 may start with a random noise vector as a seed vector, and progressively removes “noise” from the seed vector as conditioned by the text embeddings 212 such that the resulting latent representation 213 may gradually align with the text description 202. Details of the training and inference process of the denoising diffusion model of vDiT 110 may be provided below in relation to FIG. 2B.

Referring back to FIG. 2A, in one embodiment, vDiT 110 may comprise a stack of spatial-temporal transformer blocks as illustrated in FIG. 2A. Each transformer module comprises one or more modulation layers to scale and/or shift a representation vector, a spatial self-attention layer 215 to capture spatial information and a temporal self-attention layer 220 to capture temporal characteristics from the encoded video, and a feed forward layer to generate an output from the Transformer block. For example, a noised latent representation 209 may be input to a modulation layer, together time the time embedding 211 having the same time index t corresponding to the noised latent representation 209. The modulation layer may in turn scale and/or shift the combined embeddings and pass on to the spatial self-attention layer 215. Additional details of the spatial self-attention layer 215 and the temporal self-attention layer 220 are provided below in relation to FIGS. 2C-2D.

For example, FIGS. 2C-2D are simplified diagrams illustrating ab example modules in the t2v generation model described in FIG. 2A, according to some embodiments. As shown in FIG. 2C-2D, both the spatial self-attention layer 215 and the temporal self-attention layer 220 incorporate a pre-norm layer and a multi-head self-attention (MHA) layer. In FIG. 2C, the temporal self-attention layer 220 may adopt Rotary Positional Embedding (RoPE) to encode temporal information, e.g., to compute attentions between an input matrix having a size of (B, H, W) capturing visual information of each frame in the batch (here B=batch size, H=height of a frame, W=width of a frame), an input vector having a size of (T) representing the number of frames in the input video, and an input vector having a size of C representing the number of image channels of each frame. In FIG. 2D, the spatial self-attention layer 215 may adopt sinusoidal encoding to encode spatial information, e.g., to compute attentions between an input matrix having a size of (B, T) capturing the batch size and the total number of frames in the input video, input matrix (H, W) capturing spatially distributed visual content on each frame and the input vector having a size of C representing the number of image channels of each frame.

Referring back to FIG. 2A, the VDiT 110 may further comprise a cross-attention layer that computes the cross-attention between the text embeddings 212 and output attentions from the temporal self-attention layer 220. In this way, each transformer block of the vDiT 110 may capture both the spatial and temporal attentions among the latent representation of a video (e.g., which spatial portions on a video frame are correlated, and/or which temporal portions of a video are correlated), and then capture the cross-attention between the video 203 and the text 202 (e.g., which portions of the text correlate and/or correspond to which temporal and/or spatial portion of the video 203).

FIG. 2B is a simplified diagram illustrating an exemplary training framework 200 for a denoising diffusion model for generating a video given a conditioning input such as a text prompt. Framework 200 illustrates how such a diffusion model of vDiT 110 may be trained to generate a video 216 given a prompt 202 by gradually removing noise from a seed vector. The top portion of the illustrated framework 200 including VAE encoder 115 and the noise ε 208 steps may only be used during the training process, and not at inference, as described below. A training dataset may include a variety of videos 203, which do not necessarily require any annotations, but may be associated with information such as a caption for each video in the training dataset that may be used as a conditioning input 202. A training video may be used as input 203. Encoder 115 may encode input 203 into a latent representation (e.g., a vector) which represents the video.

Latent vector representation z₀ 205a represents the first encoded latent representation of input 203. Noise ε 208 is added to the representation z₀ₒ 205a to produce representation z₁ 205b. Noise ε 208 is then added to representation z₁ 205b to produce an even noisier representation. This process is repeated multiple times (e.g., 50 iterations) until it results in a noised latent representation z_{T} 206t. The random noise ε 208 added at each iteration may be a random sample from a probability distribution such as Gaussian distribution. The amount (i.e., variance) of noise ε 208 added at each iteration may be constant, or may vary over the iterations. The amount of noise ε 208 added may depend on other factors such as video size or resolution.

This process of incrementally adding noise to latent video representations effectively generates training data that is used in training the diffusion denoising model 222, as described below. As illustrated, denoising model ε_{θ} 222 is iteratively used to reverse the process of noising latents (i.e., perform reverse diffusion) from z′_{T} 218t to z′₀ 218a. Denoising model ε_{θ} 222 may be a neural network based model, which has parameters that may be learned. Input to denoising model ε_{θ} 222 may include a noisy latent representation (e.g., noised latent representation z_{T} 206t), and conditioning input 202 such as a text prompt describing desired content of an output video. For example, the text prompt 202 may affect the denoising process performed by vDiT 210 through injecting the text embeddings of 202 into the cross-attention layer as discussed above in relation to FIG. 2A.

As shown, the noisy latent representation may be repeatedly and progressively fed into denoising model 222 to gradually remove noise from the latent representation vector based on the conditioning input 202, e.g., from z′_{T} 218t to z′₀ 218a.

In one embodiment, the progressive outputs of repeated denoising models ε_{θ} 222 z′_{T} 218t to z′₀ 218a may be an incrementally denoised version of the input latent representation z′_{T} 218t, as conditioned by a conditioning input 210. The latent video representation produced using denoising model ε_{θ} 222 may be decoded using VAE decoder 120 to provide an output 216 which is the denoised video.

In one embodiment, the output video 216 is then compared with the input training video 203 to compute a loss for updating the denoising model 212 via back propagation. In another embodiment, the latent representation 206a of input 203 may be compared with the denoised latent representation 218a to compute a loss for training. In another embodiment, a loss objective may be computed comparing the noise actually added (e.g., by noise ε 208) with the noise predicted by denoising model ε_{θ} 222.

For example, given conditioning caption signals (y) (e.g., the training text 202), the loss objective may be computed as:

$${ℒ}_{LDM} := {𝔼}_{Z ∼ E z ( x ) , ε ∼ N ( 0 , 1 ) , t , y} [ ‖ ε - {ε}_{θ} ( {z}_{t} , t , {c}_{ϕ} ( y ) ) ‖ ] \qquad ( 1 )$$

where t represents the time step, zₜ is the noise corrupted latent tensor at time step t, and z₀= [symbol] (x). ε is the unscaled Gaussian noise, c_{ϕ} is the conditioning network (e.g., the cross attention layer) parameterized by ϕ and ε_{θ} is the Transformer-like denoising network (denoising model 222). The parameters of both conditioning and denoising networks θ, ϕ, are trained by the LDM loss. During inference, clean videos can be generated via classifier-free guidance (such as a text prompt) as:

$${\hat{ε}}_{θ} ( {z}_{t} \vert y ) = {ε}_{θ} ( {z}_{t} ) + \cdot ( ε {}_{θ} ( {z}_{t} , {c}_{ϕ} ( y ) ) - {ε}_{θ} ( {z}_{t} ) ) \qquad ( 2 )$$

where & is the guidance weight to balance text controllability.

Denoising model ε_{θ} 222 may be trained based on this loss objective (e.g., parameters of denoising model ε_{θ} 222 may be updated in order to minimize the loss by gradient descent using backpropagation). Note that this means during the training process of denoising model ε_{θ} 222, an actual denoised video does not necessarily need to be produced (e.g., output 216 of decoder 214), as the loss is based on each intermediate noise estimation, not necessarily the final video.

At inference, denoising model ε_{θ} 222 may be used to denoise a latent video representation given a conditioning input such as a text prompt (e.g., 102 in FIG. 1). Rather than a noisy latent video representation z_{T} 206t, the input to the sequence of denoising models may be a randomly generated vector which is used as a seed. Different videos may be generated by providing different random starting seeds. The resulting denoised latent video representation after T denoising model steps may be decoded by a decoder (e.g., VAE decoder 120) to produce an output 216 of a denoised video. For example, conditioning input may include a description of a video, and the output 216 may be a video which is aligned with that description.

Note that while denoising model ε_{θ} 222 is illustrated as the same model being used iteratively, distinct models may be used at different steps of the process. Further, note that a “denoising diffusion model” may refer to a single denoising model ε_{θ} 222, a chain of multiple denoising models ε_{θ} 222, and/or the iterative use of a single denoising model ε_{θ} 222. A “denoising diffusion model” may also include related features such as decoder 120, any pre-processing that occurs to conditioning input such as a text prompt 202, etc. This framework 200 of the training and inference of a denoising diffusion model may further be modified to provide improved results and/or additional functionality, for example as in embodiments described herein.

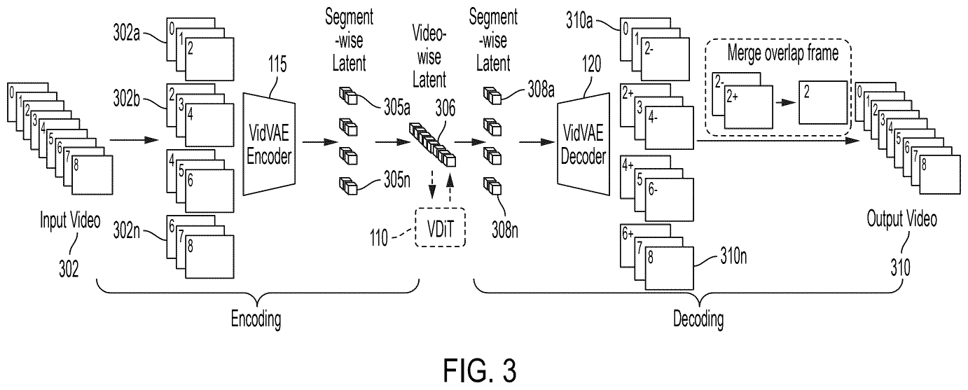

FIG. 3 is a simplified diagram illustrating an example long video compression encoding process in the training framework described in FIG. 2A, according to some embodiments. In one embodiment, the video VAE encoder 115 may achieving a 4×8×8 compression with spatial and temporal dimension reduction, but the computation cost remains a significant bottleneck, particularly as video sizes increase, leading to substantial memory demands. To address the out-of-memory (OOM) issues encountered during long video encoding, a divide-and-merge strategy may be adopted as shown in FIG. 3.

With reference to FIG. 3, given a long input video 302, the long video 302 may be split into multiple segments 302a-302n. Each segment 302a-n consists of multiple frames (e.g., different segment may have the same number or different number of frames), with overlapping frames at both the beginning and end of each segment. These segments 302a-n are then encoded by the video VAE encoder 115 individually. The overlapping frames between segments 302a-302n thus maintain strong temporal consistency in the resulting segment-wise latent representations 305a-305n. The segment-wise latent representations 305a-305n may then be combined into a video-wise latent representation 306 to be fed to vDiT 110. In this way, computational efficiency of encoding the input video 302 is improved with lower demand in memory and processing capacity of hardware. In this way, with the encoding compression approach, the video generation model can generate over 100 frames of 720p video in an end-to-end manner, while mitigating additional computation costs.

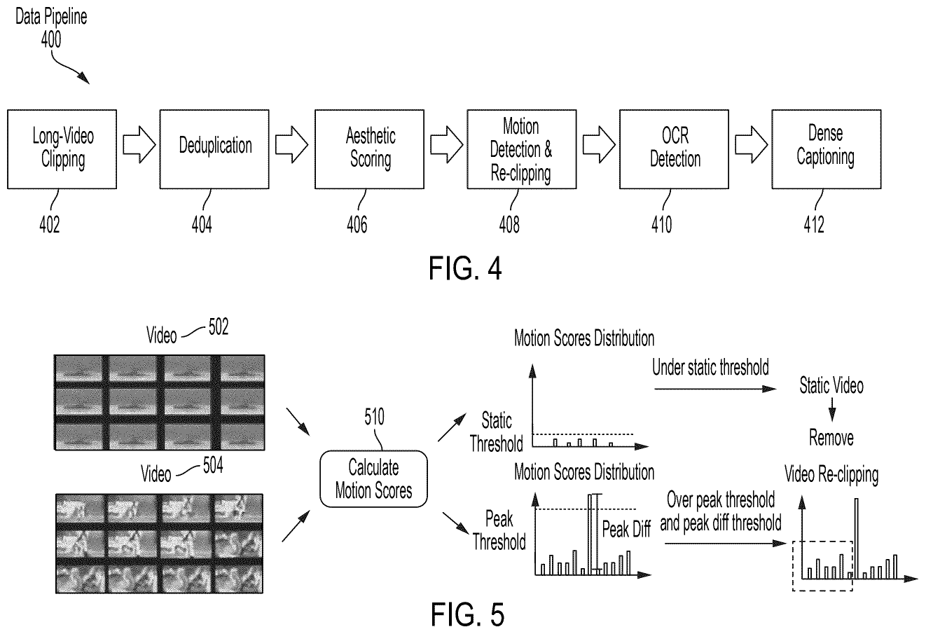

FIG. 4 is a simplified diagram illustrating a data pipeline 400 for generating video-text training data for training the text-to-video generation model described in FIG. 1, according to some embodiments. First, a long-video clipping module 402 splits long videos into manageable clips. For example, original long videos are cut into multiple shorter clips. Each clip is intended to represent a distinct and clean scene. However, some clips may still contain redundant or inconsistent scenes. These cases are addressed in subsequent steps.

Then, a duplication module 404 removes similar and redundant clips. The clipping process at module 402 can sometimes yield clips that are highly similar to one another. To address this, a de-duplication module 404 filters out redundant clips. For example, frames are extracted and the clip-as-a-service tool can be used to efficiently extract CLIP features and compute similarity scores between clips. In each duplicate pair, the shorter clip is removed based on a similarity score threshold, τ. Through empirical analysis, a threshold of τ=0.9 may be adopted for identifying duplicates.

Next, an aesthetic scoring module 406 analyzes aesthetics and motion dynamics across frames to eliminate static video clips and inconsistent frames. To provide high-quality training data, it is crucial to use video clips that are well-lit, well-composed, and have clear footage. To filter out poor-quality data, the Aesthetic Score—a measure of how visually pleasing a video is, is computed. A neural network may be trained on human aesthetic scores of images. This network, which takes CLIP features as input, outputs a score ranging from 0 to 10. Clips with an Aesthetic Score below 4.5 are filtered out.

After that, a motion detection and re-clipping module 408 identifies and removes clips contaminated with text or watermarks. FIG. 5 is a simplified diagram illustrating the motion detection and re-clipping of training videos in the data pipeline described in FIG. 4, according to some embodiments. For example, module 408 may compute motion scores 510 for various videos 502, 504 to eliminate videos that are nearly static, e.g., by comparing with a static threshold and/or a peak threshold. After the initial video clipping, some videos may still exhibit sudden scene changes. Thus, these videos may be re-clipped to ensure consistency and maintain a unified topic throughout. Frame differencing may be used to detect motion within a video, followed by motion-based re-clipping. The process commences with the computation of grayscale frame differences, where each frame may be subtracted from its predecessor in the sequence. This technique, while effective, can introduce background noise, manifesting as speckles that falsely indicate motion. These artifacts typically stem from minor camera shakes or the presence of multiple shadows. To counteract this, a threshold is implemented on the frame differences to create a binary motion mask. A motion score 510 is thus computed by taking the mean of the motion mask values.

Guided by the motion score 510, both motion detection and re-clipping may be performed. An overall illustration is shown in FIG. 5—the average motion score 510 is computed across the videos 502, 504 and a threshold is set. Videos falling below this static threshold are deemed nearly static and subsequently removed. For the re-clipping, the goal is eliminating significant, sudden scene changes. The frame with the highest motion score may be identified and the motion score differences may be analyzed with its neighboring frames. If both the peak motion score and the differences surpass predefined thresholds, this flags a major scene change. Here, the video may be segmented at this critical frame. A longer segment may be retained to ensure it meets the length requirement and is devoid of further disruptive transitions.

Referring back to FIG. 4, an OCR module 410 evaluates and scores the visual quality of clips before adding descriptive captions to the clips. For example, OCR may detect text in the video in order to get high quality video data. Text detection is performed on key frames from the videos. The text detection model may comprise a lightweight model supporting Chinese, English, and multilingual text detection. In this step, videos where the size of the bounding box is smaller than 20000 pixels may be kept.

Finally, a captioning module 412 may add descriptive captions to the clips. For example, a multimodal video LLM may be trained to generate video captions. This model takes a sequence of frames from the video as an input, and is trained to generate text captions describing the contents of the video as an output.

In one embodiment, the captioning module 412 may comprise a video captioning model composed of the following four components: (1) a vision encoder (ViT) taking each frame input, (2) a frame-level tokenizer to reduce the number of tokens, (3) a temporal encoder to build video-level token representations, and (4) a LLM generating output text captions based on such video tokens and text prompt tokens. Specifically, a pretrained vision encoder may be configured to take one single image frame at a time, mapping such visual tokens into N=128 visual tokens per frame. The temporal encoder is implemented with Token Turing Machines (TTM), which is a sequential model capable of taking any number of frames to generate a video-level token representation (e.g., M=128 tokens regardless the number of frames). A multimodal LLM taking such video tokens in addition to the text prompt tokens. For computational efficiency, the model takes uniformly sampled 4 frames per video. In this way, a video is mapped into around 4×700 visual tokens. These visual tokens are then mapped to 4×128 visual tokens using Perceiver-Resampler and then to 128 video tokens using TTM. The captioning model is first pretrained with standard image caption datasets. The model is then finetuned with the LLaVA-Hound-DPO training dataset, providing video captions over 900 k frames.

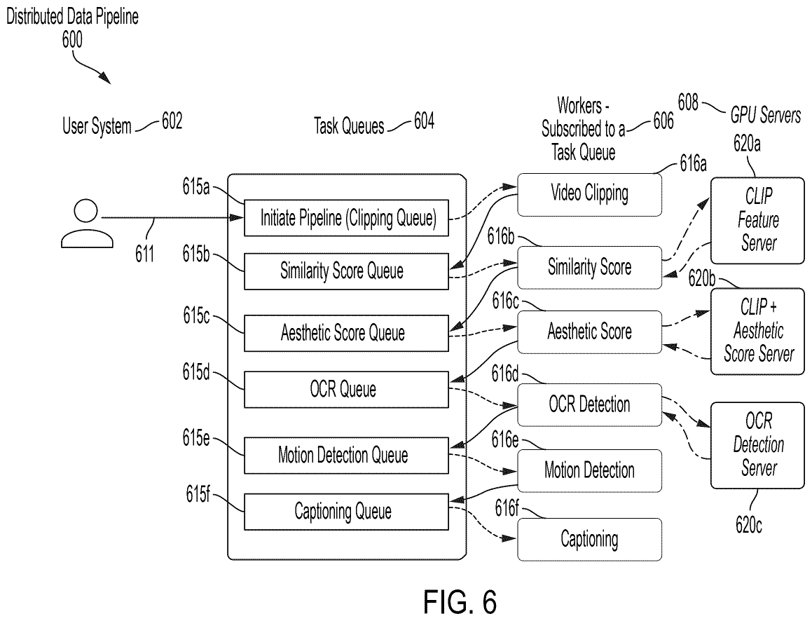

FIG. 6 is a simplified diagram illustrating a distributed implementation 600 of the data pipeline described in FIG. 4, according to some embodiments. To efficiently orchestrate the data processing and filtering steps 402-412 described above with minimal manual intervention and optimal resource utilization, a distributed data processing pipeline 600 is employed.

The Distributed Data Processing Pipeline 600 may comprise: 1. each process (one of the six steps above) is able to use its own resource specs. For example, clipping is CPU based, captioning is GPU based; 2. each process is independently scalable without interrupting the process flow. For example, clipping is extremely fast, while similarity scoring is time consuming. Hence, clipping may be independently scale-down and similarity scoring may be scale-up; 3. the downstream processes are automatically triggered after a process is completed for a video. For example, after clipping is complete for video with ID ‘A’, the similarity score computation is started for that video automatically; 4. the activation of a downstream task optionally depends on a condition. For example, motion detection for a clip is triggered only if the clip does not have a text, which is a result of the OCR detection process.

For example, each process is a deployment with its own resource specification, subscribed to a Task Queue 604. To trigger the pipeline, user system 602 may start by pushing the video IDs to the initial queue 615a, e.g., following arrow 611 in solid line. Once this is done, the clipping process 616a populates the Similarity Score Queue 615b with the video ID. The Similarity Score deployment 616b, subscribed to the corresponding queue, takes up the task, completes it, and pushes only the de-duplicated clip IDs to the Aesthetic Score queue 615c. The Aesthetic score process 616c, after computation, enqueues the OCR detection Queue 615d with only the IDs of only those clips that meet the threshold. In this fashion, the number of clips that are being processed keeps reducing with each step in the pipeline by skipping the computation for clips that do not meet the passing criteria in the previous steps in the pipeline. The rest of the processes 616e, 616f may continue to operate with relevant task queues 615e, 615f in a similar manner. The push tasks (e.g., AMQP connections) may be illustrated by solid lines, and the pull tasks (e.g., to pull tasks from workers 606 to task queues 604) may be illustrated by dashed lines.

In addition to the speed gain by skipping computation for failed clips, the speed gain is achieved due to pipelining. There is scope to further improve this by speeding up the bottleneck process, as the processing time of the pipelined system is dependent on the time taken by the bottleneck process. For example, similarity scoring 616b, aesthetic scoring 616c and/or OCR detection 616d may be allocated to respective GPU servers 620a-620c, respectively, via GRPC/HTTP connections (illustrated by dashed arrows).

### Computer and Network Environment

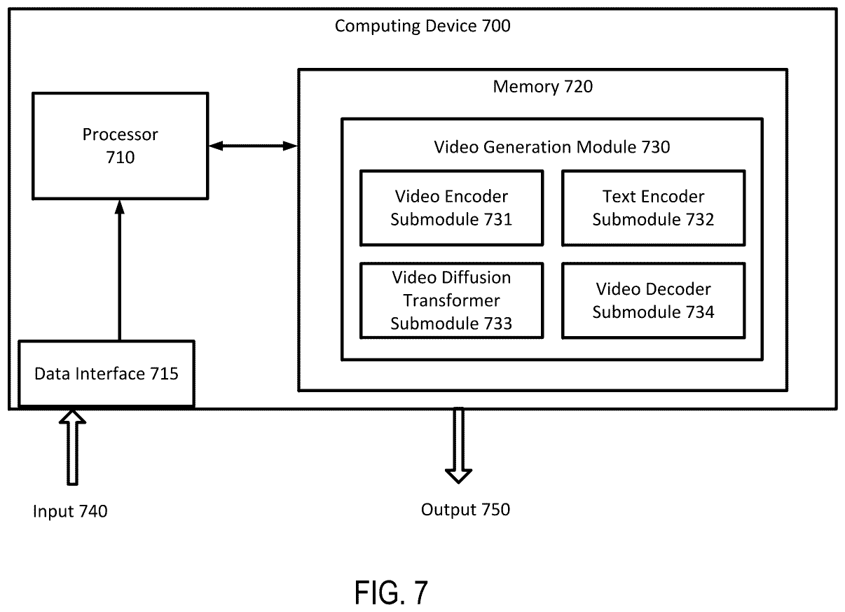

FIG. 3 is a simplified diagram illustrating a computing device implementing the text-to-generation framework described in FIGS. 1-3, according to one embodiment described herein. As shown in FIG. 7, computing device 700 includes a processor 710 coupled to memory 720. Operation of computing device 700 is controlled by processor 710. And although computing device 700 is shown with only one processor 710, it is understood that processor 710 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 700. Computing device 700 may be implemented as a stand-alone subsystem, as a board added to a computing device, and/or as a virtual machine.

Memory 720 may be used to store software executed by computing device 700 and/or one or more data structures used during operation of computing device 700. Memory 720 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 710 and/or memory 720 may be arranged in any suitable physical arrangement. In some embodiments, processor 710 and/or memory 720 may be implemented on a same board, in a same package (e.g., system-in-package), on a same chip (e.g., system-on-chip), and/or the like. In some embodiments, processor 710 and/or memory 720 may include distributed, virtualized, and/or containerized computing resources. Consistent with such embodiments, processor 710 and/or memory 720 may be located in one or more data centers and/or cloud computing facilities.

In some examples, memory 720 may include non-transitory, tangible, machine readable media that includes executable code that when run by one or more processors (e.g., processor 710) may cause the one or more processors to perform the methods described in further detail herein. For example, as shown, memory 720 includes instructions for video generation module 730 that may be used to implement and/or emulate the systems and models, and/or to implement any of the methods described further herein. Video generation module 730 may receive input 740 such as an input text description via the data interface 715 and generate an output 750 which may be a video.

The data interface 715 may comprise a communication interface, a user interface (such as a voice input interface, a graphical user interface, and/or the like). For example, the computing device 700 may receive the input 740 (such as a training dataset of video-text pairs) from a networked database via a communication interface. Or the computing device 700 may receive the input 740, such as an input text, from a user via the user interface.

In some embodiments, the video generation module 730 is configured to generate a video based on an input text. The video generation module 730 may further include a video encoder submodule 731 (e.g., similar to VAE encoder 115), a text encoder submodule 732 (e.g., similar to 210), a video diffusion Transformer submodule 733 (e.g., similar to vDiT 110) and a video decoder 734 (e.g., VAE decoder 120).

Some examples of computing devices, such as computing device 700 may include non-transitory, tangible, machine readable media that include executable code that when run by one or more processors (e.g., processor 710) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

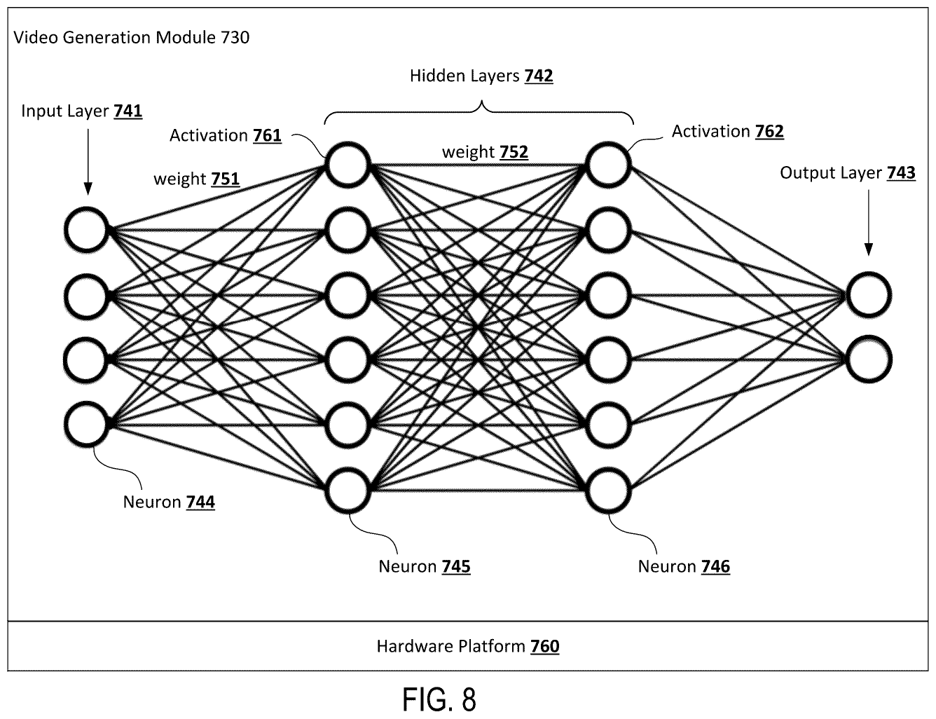

FIG. 8 is a simplified diagram illustrating the neural network structure implementing the video generation module 730 described in FIG. 7, according to some embodiments. In some embodiments, the video generation module 730 and/or one or more of its submodules 731-334 may be implemented at least partially via an artificial neural network structure shown in FIG. 7. The neural network comprises a computing system that is built on a collection of connected units or nodes, referred to as neurons (e.g., 744, 745, 746). Neurons are often connected by edges, and an adjustable weight (e.g., 751, 752) is often associated with the edge. The neurons are often aggregated into layers such that different layers may perform different transformations on the respective input and output transformed input data onto the next layer.

For example, the neural network architecture may comprise an input layer 741, one or more hidden layers 742 and an output layer 743. Each layer may comprise a plurality of neurons, and neurons between layers are interconnected according to a specific topology of the neural network topology. The input layer 741 receives the input data (e.g., 740 in FIG. 7), such as a text prompt describing options of actions, a task request, and/or the like. The number of nodes (neurons) in the input layer 741 may be determined by the dimensionality of the input data (e.g., the length of a vector of a text prompt). Each node in the input layer represents a feature or attribute of the input.

The hidden layers 742 are intermediate layers between the input and output layers of a neural network. It is noted that two hidden layers 742 are shown in FIG. 7B for illustrative purpose only, and any number of hidden layers may be utilized in a neural network structure. Hidden layers 742 may extract and transform the input data through a series of weighted computations and activation functions.

For example, as discussed in FIG. 7, the Video generation module 730 receives an input 740 of a text prompt and transforms the input into an output 750 of a task execution result. To perform the transformation, each neuron receives input signals, performs a weighted sum of the inputs according to weights assigned to each connection (e.g., 751, 752), and then applies an activation function (e.g., 761, 762, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 741 is transformed into rather different values indicative data characteristics corresponding to a task that the neural network structure has been designed to perform.

The output layer 743 is the final layer of the neural network structure. It produces the network's output or prediction based on the computations performed in the preceding layers (e.g., 741, 742). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the Video generation module 730 and/or one or more of its submodules 731-232 may comprise the transformative neural network structure of layers of neurons, and weights and activation functions describing the non-linear transformation at each neuron. Such a neural network structure is often implemented on one or more hardware processors 710, such as a graphics processing unit (GPU). An example neural network may be a Transformer based language model, and/or the like.

In one embodiment, the Video generation module 730 and its submodules 731-232 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

In one embodiment, the Video generation module 730 and its submodules 731-232 may be implemented by hardware, software and/or a combination thereof. For example, the Video generation module 730 and its submodules 731-232 may comprise a specific neural network structure implemented and run on various hardware platforms 760, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 760 used to implement the neural network structure is specifically configured based on factors such as the complexity of the neural network, the scale of the tasks (e.g., training time, input data scale, size of training dataset, etc.), and the desired performance.

In one embodiment, the neural network based Video generation module 730 and one or more of its submodules 731-232 may be trained by iteratively updating the underlying parameters (e.g., weights 751, 752, etc., bias parameters and/or coefficients in the activation functions 761, 762 associated with neurons) of the neural network based on the loss. For example, during forward propagation, the training data such as training video-text pairs are fed into the neural network. The data flows through the network's layers 741, 742, with each layer performing computations based on its weights, biases, and activation functions until the output layer 743 produces the network's output 750. In some embodiments, output layer 743 produces an intermediate output on which the network's output 750 is based.

The output generated by the output layer 743 is compared to the expected output (e.g., a “ground-truth” annotated in training data) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 743 to the input layer 741 of the neural network. These gradients quantify the sensitivity of the network's output to changes in the parameters. The chain rule of calculus is applied to efficiently calculate these gradients by propagating the gradients backward from the output layer 743 to the input layer 741.

In one embodiment, the neural network based Video generation module 730 and one or more of its submodules 731-232 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

In one embodiment, video generation module 730 and its submodules 731-334 may be housed at a centralized server (e.g., computing device 700) or one or more distributed servers. For example, one or more of Video generation module 730 and its submodules 731-334 may be housed at an external servers. The different modules may be communicatively coupled by building one or more connections through application programming interfaces (APIs) for each respective module. Additional network environment for the distributed servers hosting different modules and/or submodules may be discussed in FIG. 7.

During a backward pass, parameters of the neural network are updated backwardly from the last layer to the input layer (backpropagating) based on the computed negative gradient using an optimization algorithm to minimize the loss. The backpropagation from the last layer 743 to the input layer 741 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as processing a new task.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in artificial and/or virtual agent operations.

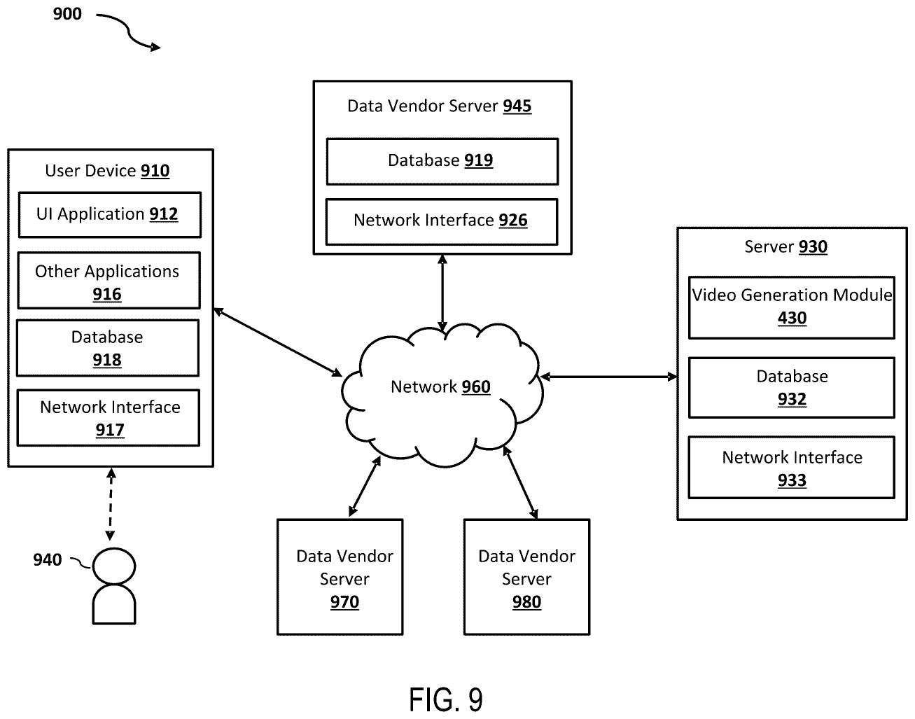

FIG. 9 is a simplified block diagram of a networked system 900 suitable for implementing the video generation framework described in FIG. 1 and other embodiments described herein. In one embodiment, system 900 includes the user device 910 which may be operated by user 940, data vendor servers 945, 970 and 980, server 930, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3, operating an OS such as a MICROSOFT® OS, a UNIX® OS, a LINUX® OS, or other suitable device and/or server-based OS. It can be appreciated that the devices and/or servers illustrated in FIG. 9 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 910, data vendor servers 945, 970 and 980, and the server 930 may communicate with each other over a network 960. User device 910 may be utilized by a user 940 (e.g., a driver, a system admin, etc.) to access the various features available for user device 910, which may include processes and/or applications associated with the server 930 to receive an output data anomaly report.

User device 910, data vendor server 945, and the server 930 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 900, and/or accessible over network 960.

User device 910 may be implemented as a communication device that may utilize appropriate hardware and software configured for wired and/or wireless communication with data vendor server 945 and/or the server 930. For example, in one embodiment, user device 910 maybe implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 910 of FIG. 9 contains a user interface (UI) application 912, and/or other applications 916, which may correspond to executable processes, procedures, and/or applications with associated hardware. For example, the user device 910 may receive a message indicating a generated video from the server 930 and display the message via the UI application 912. In other embodiments, user device 910 may include additional or different modules having specialized hardware and/or software as required.

In one embodiment, UI application 912 may communicatively and interactively generate a UI for an AI agent implemented through the Video generation module 330 (e.g., an LLM agent) at server 930. In at least one embodiment, a user operating user device 910 may enter a user utterance, e.g., via text or audio input, such as a question, uploading a document, and/or the like via the UI application 912. Such user utterance may be sent to server 930, at which video generation module 330 may generate a response via the process described in FIG. 1. The video generation module 330 may thus cause a display of the generated video output at UI application 912 and interactively update the display in real time with the user utterance.

In various embodiments, user device 910 includes other applications 916 as may be desired in particular embodiments to provide features to user device 910. For example, other applications 916 may include security applications for implementing client-side security features, programmatic client applications for interfacing with appropriate application programming interfaces (APIs) over network 960, or other types of applications. Other applications 916 may also include communication applications, such as email, texting, voice, social networking, and IM applications that allow a user to send and receive emails, calls, texts, and other notifications through network 960. For example, the other application 916 may be an email or instant messaging application that receives a prediction result message from the server 930. Other applications 916 may include device interfaces and other display modules that may receive input and/or output information. For example, other applications 916 may contain software programs for asset management, executable by a processor, including a graphical user interface (GUI) configured to provide an interface to the user 940 to view the generated video.

User device 910 may further include database 918 stored in a transitory and/or non-transitory memory of user device 910, which may store various applications and data and be utilized during execution of various modules of user device 910. Database 918 may store user profile relating to the user 940, predictions previously viewed or saved by the user 940, historical data received from the server 930, and/or the like. In some embodiments, database 918 may be local to user device 910. However, in other embodiments, database 918 may be external to user device 910 and accessible by user device 910, including cloud storage systems and/or databases that are accessible over network 960.

User device 910 includes at least one network interface component 917 adapted to communicate with data vendor server 945 and/or the server 930. In various embodiments, network interface component 917 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 945 may correspond to a server that hosts database 919 to provide training datasets including training tasks to the server 930. The database 919 may be implemented by one or more relational database, distributed databases, cloud databases, and/or the like.

The data vendor server 945 includes at least one network interface component 926 adapted to communicate with user device 910 and/or the server 930. In various embodiments, network interface component 926 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 945 may send asset information from the database 919, via the network interface 926, to the server 930.

The server 930 may be housed with the Video generation module 330 and its submodules described in FIG. 3. In some implementations, video generation module 330 may receive data from database 919 at the data vendor server 945 via the network 960 to generate a video. The generated video may also be sent to the user device 910 for review by the user 940 via the network 960.

The database 932 may be stored in a transitory and/or non-transitory memory of the server 930. In one implementation, the database 932 may store data obtained from the data vendor server 945. In one implementation, the database 932 may store parameters of the Video generation module 330. In one implementation, the database 932 may store previously generated videos, and the corresponding input feature vectors.

In some embodiments, database 932 may be local to the server 930. However, in other embodiments, database 932 may be external to the server 930 and accessible by the server 930, including cloud storage systems and/or databases that are accessible over network 960.

The server 930 includes at least one network interface component 933 adapted to communicate with user device 910 and/or data vendor servers 945, 970 or 980 over network 960. In various embodiments, network interface component 933 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 960 may be implemented as a single network or a combination of multiple networks. For example, in various embodiments, network 960 may include the Internet or one or more intranets, landline networks, wireless networks, and/or other appropriate types of networks. Thus, network 960 may correspond to small scale communication networks, such as a private or local area network, or a larger scale network, such as a wide area network or the Internet, accessible by the various components of system 500.

### Example Work Flow

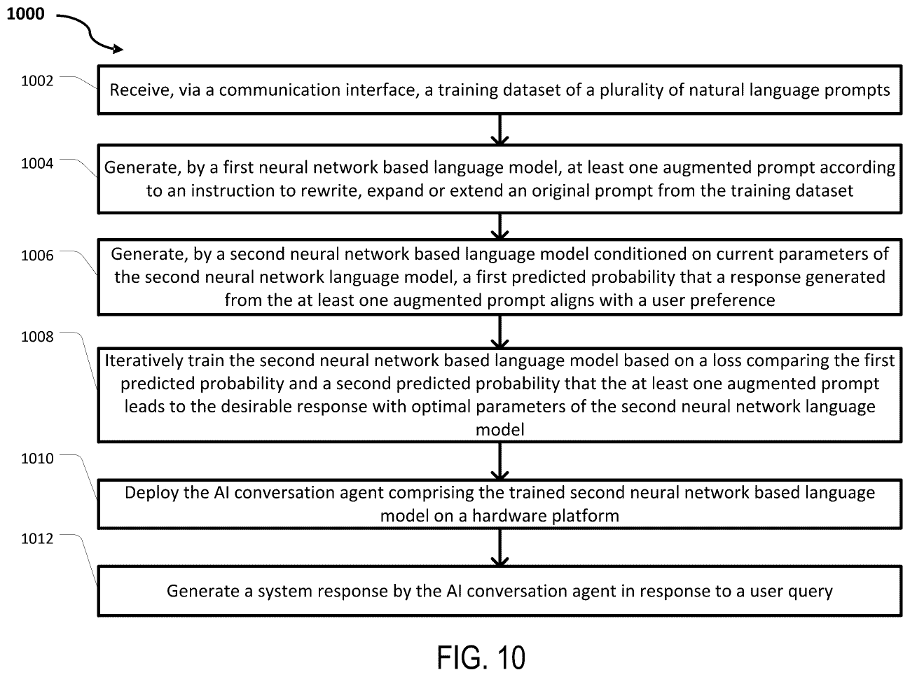

FIG. 10 is a simplified logic flow diagram of automatically generating a video based on a text description based on the text-to-generation framework described in FIGS. 1-9 and other embodiments described herein.

One or more of the processes of method 1000 maybe implemented, at least in part, in the form of executable code stored on non-transitory, tangible, machine-readable media that when run by one or more processors may cause the one or more processors to perform one or more of the processes. In some embodiments, method 700 corresponds to the operation of the video generation module 730 (e.g., FIGS. 7-9) that is trained to generate a video based on a text input.

As illustrated, the method 1000 includes a number of enumerated steps, but aspects of the method 1000 may include additional steps before, after, and in between the enumerated steps. In some aspects, one or more of the enumerated steps may be omitted or performed in a different order.

At step 1002, a training video (e.g., 202 in FIG. 2A, 302 in FIG. 3) may be split into one or more video segments (e.g., 302a-n in FIG. 3) with one or more overlapping frames. For example, method 1000 may comprise obtaining the training video and a training text (e.g., 203 in FIG. 2A) describing a visual content of the training video. The training video and a corresponding training text are obtained from a video-language training dataset built using the pipeline 400 in FIG. 4.

At step 1004, a video encoder (e.g., VAE encoder 115) may encode the one or more video segments into one or more segment-wise latent representations (e.g., 305a-n in FIG. 3). Specifically, during encoding, the spatial dimensionality and/or the temporal dimensionality of the one or more video segments may be reduced. The one or more segment-wise latent representations may then be combined into a video-level latent representation (e.g., 306 in FIG. 3) corresponding to the training video.

At step 1006, a video diffusion model may be trained based on the video-level latent representation. For example, the training may comprise using a noising diffusion model to iteratively adding a random noise (e.g., 208 in FIG. 2B) to the video-level latent representation to form a noised video latent representation (e.g., 205a-205t in FIG. 2B). Then a denoising diffusion model (e.g., 222 in FIG. 2B) may be used to iteratively remove an estimated noise from the noised video latent representation conditioned on the text embedding of the training text to generate a reconstructed video latent representation (e.g., 218t-218a in FIG. 2B). The video diffusion model is then trained based on a training objective (e.g., Eq. (1)) that compares the noised video latent representation with the reconstructed video latent representation.

In one embodiment, the video diffusion model comprises a spatial attention layer (e.g., 215 in FIG. 2A), a temporal attention layer (e.g., 220 in FIG. 2A) and a text-video cross-attention layer. The spatial attention layer outputs attention weights capturing spatial information of an input vector relating to the training video. The temporal attention layer outputs attention weights capturing temporal characteristics of an input vector relating to the training video. The text-video cross-attention layer output attention weights capturing relationships between embeddings of the training text and spatial and/or temporal portions of the training video.

At step 1008, the trained video diffusion model may generate an output latent representation for the video based on an input of the text description. For example, a text encoder may encode the text description into a text embedding. A seed vector is generated from random noise, and the trained video diffusion model iteratively removes an estimated noise from the seed vector conditioned on the text embedding to generate the output latent representation.

At step 1010, a video decoder (e.g., 120 in FIG. 1, 2A) may output the video (e.g., 105 in FIG. 1, 216 in FIG. 2A) from the output latent representation.

In this way, method 1000 of text-to-video generation may improve artificial intelligence technology to transform textual descriptions into dynamic video content. The improved video generation technology may further improve a wide variety of practical applications. In education, method 1000 can create customized instructional videos tailored to specific learning needs. In computer animation and gaming industry, gaming developers use it to prototype scenes quickly, while content creators produce visual stories efficiently. For training simulations, it generates realistic scenarios for fields like healthcare or aviation. Additionally, in scientific research, it visualizes abstract concepts or complex data. Therefore, method 1000 and embodiments described in FIGS. 1-10 democratize video creation, making it accessible and efficient across industries requiring rapid and adaptable media.

### Example Data Experiments

Example data experiments of the video generation model is conducted with a 731 M diffusion transformer with a 244 M video VAE model, trained sequentially. See more details in Table 1.

TABLE 1
Settings of different text-to-video models

| | | | | | Max | Max | |
|---|---|---|---|---|---|---|---|
| Methods | #Params | GPU Days | Data | VAE | Resolution | Duration | |
| OpenSoraPlan | 1.0B | 240 (H100) + | 4.8M | 4 × 8 × 8 | 512 × 512 | 9.2 | s |
| V1.1 | | 1536 (Ascend) | | | | | |
| OpenSoraPlan | 2.77B | 1578 (H100) + | 6.1M | 4 × 8 × 8 | 720 p | 4 | s |
| V1.2 | | 500 (Ascend) | | | | | |
| OpenSora V1.1 | 700M | 576 (H800) | 10M | 1 × 8 × 8 | 720 p | 4 | s |
| OpenSora V1.2 | 1.1B | 1458 (H100) | >30M | 4 × 8 × 8 | 720 p | 16 | s |
| Video | 731M | 672 (H100) | 13M | 4 × 8 × 8 | 720 p | 14 | s |
| Generation | | | | | | | |
| model | | | | | | | |

The video VAE model (e.g., 115) can compress the video by 4×8×8. It is trained on a subset of the Kinetics dataset and additional high-quality internal videos. Multi-scale images and videos are sample d from the training set, including resolutions of 1×768×768, 17×512×512, and 65×256×256. The model, initialized with the image VAE, requires 40 H100 days to train.

The video DiT model (e.g., 110) features 28 stacked transformer blocks, with each multi-head attention (MHA) layer consisting of 16 attention heads and a feature dimension of 1152. This DiT model encompasses 731 million parameters in total. We adopt a training pipeline similar to OpenSora V1.1, utilizing multiple buckets to accommodate various sizes, aspect ratios, and durations. The DiT model is initialized using the PixArt-Alpha model and undergoes training in three stages: the first stage with videos up to 240p, the second stage with videos up to 480p, and the third stage with videos up to 720p. AdamW with a default learning rate of 2e-5 is used in training and the final checkpoint is obtained through exponential moving average (EMA). The overall training process spans approximately 672 H100 days. This DiT model can support up to 14 s 720p video generation.

Vbench scores (Huang et al., Vbench: Comprehensive benchmark suite for video generative models, in Proceedings of the IEEE/CVF Conference on Computer Vision and Pattern Recognition, pages 21807-21818, 2024) may be used to quantitatively evaluate the text-to-video generation results. Tab 2 presents various scores for comprehensive evaluation. These scores are categorized into the following metrics: “Consistency” (including Background Consistency, Subject Consistency, and Overall Consistency), “Aesthetic” (including Aesthetic, Image Quality, and Color), “Temporal” (including Temporal Flickering, Motion Smoothness, and Human Action), and “Spatial” (spatial relationship). OpenSora V1.1, which is comparable to our model in size (˜700 M) and training cost, provides a fair benchmark. The Model Scope represents a Stable Diffusion-based method. We conduct the evaluation of OpenSora V1.1 and Ours under the same setting. ModelScope's scores are referred to the official table. As shown in Tab. 2, the proposed video generation model outperforms the baselines in “Aesthetic,” “Spatial”, and average results, while performing comparably to the baselines in other metrics.

TABLE 2
Vbench T2V score

| Methods | Consistency | Temporal | Aesthetic | Spatial | Avg |
|---|---|---|---|---|---|
| ModelScope [20] | 0.702 | 0.955 | 0.641 | 0.337 | 0.659 |
| OpenSora V1.1 | 0.716 | 0.941 | 0.599 | 0.520 | 0.694 |
| [13] | | | | | |
| Video generation | 0.714 | 0.947 | 0.655 | 0.523 | 0.709 |
| model | | | | | |

To further assess the reconstruction capacity of our trained video VAE, the training framework randomly sampled 1,000 videos from the Kinetics (Chen et al., Panda-70 m: Captioning 70 m videos with multiple cross-modality teachers. arXiv preprint arXiv:2402.19479, 2024) and OpenVid1M (Nan et al., Openvid-1 m: A large-scale high-quality dataset for text-to-video generation, arXiv preprint arXiv:2407.02371, 2024) datasets, ensuring these videos were not included in the training set. VAE model may encode and decode these videos, expecting the outputs to be identical to the inputs. We evaluated the results using PSNR, SSIM (Hore et al., Image quality metrics: PSNR vs. SSIM, in 2010 20th International Conference on Pattern Recognition, pages 2366-2369, 2010. doi: 10.1109/ICPR.2010.579), and mean squared error (MSE) metrics. Table 3 illustrates example quantitative results of the text-to-video generation results.

TABE 3
VideoVAE quantitative evaluation

| | 1 × 768 × 768 | | | 17 × 512 × 512 | | | 65 × 256 × 256 | | |
|---|---|---|---|---|---|---|---|---|---|
| | PSNR | SSIM | MSE | PSNR | SSIM | MSE | PSNR | SSIM | MSE |
| Methods | ↑ | ↑ | ↓ | ↑ | ↑ | ↓ | ↑ | ↑ | ↓ |
| Image VAE | 40.98 | 0.972 | 0.00067 | 37.59 | 0.951 | 0.00152 | 32.54 | 0.901 | 0.00472 |
| [2] | | | | | | | | | |
| OpenSoraPlan | 39.15 | 0.973 | 0.00082 | 33.62 | 0.934 | 0.00289 | 30.06 | 0.874 | 0.00814 |
| [21] | | | | | | | | | |
| Video | 39.41 | 0.971 | 0.00082 | 33.83 | 0.935 | 0.00281 | 29.68 | 0.879 | 0.00780 |
| generation | | | | | | | | | |
| model | | | | | | | | | |

As shown in Tab. 3, the proposed model outperforms the baseline video VAE from OpenSoraPlan, which has the same compression ratio of 4×8×8, in most scenarios. Nevertheless, there remains a significant gap between the image VAE and video VAE 115, indicating substantial potential for future improvements. The image VAE cannot compress videos at the time dimension which leaves huge redundancy in computation.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for automatically generating a video based on a text description, comprising:
splitting, a training video into one or more video segments with one or more overlapping frames;
encoding, by a video encoder, the one or more video segments into one or more segment-wise latent representations, comprising:
reducing a spatial dimensionality and/or a temporal dimensionality of the one or more video segments during the encoding, and
combining the one or more segment-wise latent representations into a video-level latent representation corresponding to the training video;
training a video diffusion model based on the video-level latent representation,
and
generating, by the trained video diffusion model, an output latent representation for the video based on an input of the text description; and
outputting, by a video decoder, the video from the output latent representation.

2. The method of claim 1, further comprising:
obtaining the training video and a training text describing a visual content of the training video; and
encoding, by a text encoder, the training text into a text embedding.

3. The method of claim 2, wherein training the video diffusion model comprises:
iteratively adding a random noise to the video-level latent representation to form a noised video latent representation;
iteratively removing, by the video diffusion model, an estimated noise from the noised video latent representation conditioned on the text embedding to generate a reconstructed video latent representation; and
training the video diffusion model based on a training objective that compares the noised video latent representation with the reconstructed video latent representation.

4. The method of claim 3, wherein the video diffusion model comprises a spatial attention layer, a temporal attention layer and a text-video cross-attention layer.

5. The method of claim 4, wherein the spatial attention layer outputs attention weights capturing spatial information of an input vector relating to the training video.

6. The method of claim 5, wherein the temporal attention layer outputs attention weights capturing temporal characteristics of an input vector relating to the training video.

7. The method of claim 6, wherein the text-video cross-attention layer output attention weights capturing relationships between embeddings of the training text and spatial and/or temporal portions of the training video.

8. The method of claim 1, wherein the generating the output latent representation comprises:
encoding, by a text encoder, the text description into a text embedding;
generating a seed vector from random noise;
iteratively removing, by the trained video diffusion model, an estimated noise from the seed vector conditioned on the text embedding to generate the output latent representation.

9. The method of claim 1, wherein the training video and a corresponding training text are obtained from a video-language training dataset, and wherein the video-language training dataset is obtained by:
splitting an original long video into one or more training segments;
filtering out redundant segments from the one or more training segments; and
generating a motion detection score to filter out segments having motion detection scores that are lower than a threshold.

10. The method of claim 9, further comprising:
generating, by one or more multimodal language models, one or more text captions for one or more remaining video segments after the filtering.

11. A system for automatically generating a video based on a text description, comprising:
one or more memories storing a plurality of processor-executed instructions; and
a processor executing the plurality of processor-executed instructions to perform operations comprising:
splitting, a training video into one or more video segments with one or more overlapping frames;
encoding, by a video encoder, the one or more video segments into one or more segment-wise latent representations, comprising:
reducing a spatial dimensionality and/or a temporal dimensionality of the one or more video segments during the encoding, and
combining the one or more segment-wise latent representations into a video-level latent representation corresponding to the training video;
training a video diffusion model based on the video-level latent representation, and
generating, by the trained video diffusion model, an output latent representation for the video based on an input of the text description; and
outputting, by a video decoder, the video from the output latent representation.

12. The system of claim 11, wherein the operations further comprise:
obtaining the training video and a training text describing a visual content of the training video; and
encoding, by a text encoder, the training text into a text embedding.

13. The system of claim 12, wherein the operation of raining the video diffusion model comprises:
iteratively adding a random noise to the video-level latent representation to form a noised video latent representation;
iteratively removing, by the video diffusion model, an estimated noise from the noised video latent representation conditioned on the text embedding to generate a reconstructed video latent representation; and
training the video diffusion model based on a training objective that compares the noised video latent representation with the reconstructed video latent representation.

14. The system of claim 13, wherein the video diffusion model comprises a spatial attention layer, a temporal attention layer and a text-video cross-attention layer.

15. The system of claim 14, wherein the spatial attention layer outputs attention weights capturing spatial information of an input vector relating to the training video.

16. The system of claim 15, wherein the temporal attention layer outputs attention weights capturing temporal characteristics of an input vector relating to the training video.

17. The system of claim 16, wherein the text-video cross-attention layer output attention weights capturing relationships between embeddings of the training text and spatial and/or temporal portions of the training video.

18. The system of claim 11, wherein the operation of generating the output latent representation comprises:
encoding, by a text encoder, the text description into a text embedding;
generating a seed vector from random noise;
iteratively removing, by the trained video diffusion model, an estimated noise from the seed vector conditioned on the text embedding to generate the output latent representation.

19. The system of claim 11, wherein the training video and a corresponding training text are obtained from a video-language training dataset, and wherein the video-language training dataset is obtained by:
splitting an original long video into one or more training segments;
filtering out redundant segments from the one or more training segments; and
generating a motion detection score to filter out segments having motion detection scores that are lower than a threshold; and
generating, by one or more multimodal language models, one or more text captions for one or more remaining video segments after the filtering.

20. A machine-readable storage medium storing a plurality of processor-executed instructions for automatically generating a video based on a text description, the plurality of processor-executed instructions executed by one or more processors to perform operations comprising:
splitting, a training video into one or more video segments with one or more overlapping frames;
encoding, by a video encoder, the one or more video segments into one or more segment-wise latent representations, comprising:
reducing a spatial dimensionality and/or a temporal dimensionality of the one or more video segments during the encoding, and
combining the one or more segment-wise latent representations into a video-level latent representation corresponding to the training video;
training a video diffusion model based on the video-level latent representation, and
generating, by the trained video diffusion model, an output latent representation for the video based on an input of the text description; and
outputting, by a video decoder, the video from the output latent representation.
